(19) United States
(12) Patent Application Publication
(10) Pub. No.: US 2013/0267257 A1
(43) Pub. Date: Oct. 10, 2013

(54) ACCESS POINT MEASUREMENTS FOR RECEIVED SIGNAL PREDICTION

(71) Applicants: Ravi Palanki, San Diego, CA (US); Ayman Fawzy Naguib, Cupertino, CA (US); Vinay Sridhara, Santa Clara, CA (US); Saumitra Mohan Das, San Jose, CA (US); Sameera Poduri, Santa Clara, CA (US)

(72) Inventors: Ravi Palanki, San Diego, CA (US); Ayman Fawzy Naguib, Cupertino, CA (US); Vinay Sridhara, Santa Clara, CA (US); Saumitra Mohan Das, San Jose, CA (US); Sameera Poduri, Santa Clara, CA (US)

(73) Assignee: QUALCOMM Incorporated, San Diego, CA (US)

(21) Appl. No.: 13/474,650

(22) Filed: May 17, 2012

Related U.S. Application Data
(60) Provisional application No. 61/622,372, filed on Apr. 10, 2012.

(51) Int. Cl. H04W 24/00

(52) U.S. Cl. 455/456.5

(57) ABSTRACT

Disclosed is a method for position determination, including altering or generating at least one radio heatmap value in a collection of radio heatmap values, the altering or generating based, at least in part, on a measurement of one or more characteristics of wireless signals received by a receiver at a first wireless network access point and transmitted by a transmitter at a second wireless network access point; and transmitting at least a portion of the collection of radio heatmap values including the altered or generated radio heatmap value to a mobile station as positioning assistance information.

### CLAIM OF PRIORITY UNDER 35 U.S.C. §119

This application claims priority under 35 USC 119 to U.S. Provisional Application Ser. No. 61/622,372, filed Apr. 10, 2012, and entitled, “ACCESS POINT MEASUREMENTS FOR RECEIVED SIGNAL PREDICTION”, which is assigned to the assignee hereof and which is incorporated herein by reference.

### BACKGROUND

1. Field

The subject matter disclosed herein relates to wireless communication systems, and more specifically, to position determination methods and apparatuses for use with and/or by wireless mobile stations.

2. Information

GPS and other like satellite positioning systems (SPS) have enabled navigation services for mobile handsets in outdoor environments. Since satellite signals may not be reliably received or acquired in an indoor environment, and because indoor positioning accuracy based on satellite-based positioning techniques may degrade, various non-SPS-based techniques may be employed to enable indoor navigation services. For example, mobile stations may obtain a position fix by measuring ranges to three or more terrestrial wireless access points or femto cells that are positioned at known locations. Such ranges may be measured, for example, by obtaining a MAC ID address from signals received from such access points and obtaining range measurements to the access points by measuring one or more characteristics of signals received from such access points such as, for example, signal strength and round trip delay.

A navigation system may provide navigation assistance or mapped features to a mobile station as it enters a particular area. For example, mapped features may relate to or otherwise identify certain physical objects, characteristics, or points of interest within a building or complex, etc. Thus, in certain instances, an indoor navigation system may provide a digital electronic map to a mobile station upon entering a particular indoor area, e.g., in response to a request for position assistance data. Such a digital electronic map may show indoor features such as doors, hallways, entry ways, walls, etc., points of interest such as bathrooms, pay phones, room names, stores, etc. A digital electronic map may be stored at a server to be accessible by a mobile station through selection of a URL, for example. By obtaining and displaying a digital electronic map, a mobile station may overlay a current location of a mobile station (and user) over the displayed map to provide the user with additional context, for example.

### BRIEF DESCRIPTION OF THE FIGURES

Non-limiting and non-exhaustive features will be described with reference to the following figures, wherein like reference numerals refer to like parts throughout the various figures.

FIG. 1 is a map of a building complex that includes a number of access points, according to an implementation.

FIG. 2 is a schematic block diagram of an access point system, according to an implementation.

FIG. 3 is a schematic block diagram of a communication and computing system, according to an implementation.

FIG. 4 is a flow diagram illustrating a process for utilizing access point or femto cell measurements to modify or generate a heatmap, according to an implementation.

FIGS. 5 and 6 show access points separated by walls or other barriers of a building complex, according to an implementation.

FIG. 7 shows a schematic block diagram of an access point system, according to another implementation.

FIG. 8 is a system diagram illustrating certain features of a system containing a mobile station, in accordance with an implementation.

FIG. 9 is a schematic block diagram illustrating an exemplary mobile station, in accordance with an implementation.

FIG. 10 is a schematic block diagram of an example computing platform.

### SUMMARY

In some implementations, a method for collecting heatmap information may comprise: altering or generating at least one radio heatmap value in a collection of radio heatmap values, the altering or generating based, at least in part, on a measurement of one or more characteristics of wireless signals received by a receiver at a first wireless network access point and transmitted by a transmitter at a second wireless network access point; and transmitting at least a portion of the collection of radio heatmap values including the altered or generated at least one radio heatmap value to a mobile station as positioning assistance information.

In other implementations, an apparatus for collecting heatmap information may comprise: means for altering or generating at least one radio heatmap value in a collection of radio heatmap values, the altering or generating based, at least in part, on a measurement of one or more characteristics of wireless signals received by a receiver at a first wireless network access point and transmitted by a transmitter at a second wireless network access point; and means for transmitting at least a portion of the collection of radio heatmap values including the altered or generated at least one radio heatmap value to a mobile station as positioning assistance information.

In still other implementations, an apparatus for collecting heatmap information may comprise: a non-transitory storage medium and one or more processing units to: alter or generate at least one radio heatmap value in a collection of radio heatmap values stored in the non-transitory storage medium, the altering or generating based, at least in part, on a measurement of one or more characteristics of wireless signals received by a receiver at a first wireless network access point and transmitted by a transmitter at a second wireless network access point. The apparatus may also comprise a wireless transceiver to: transmit at least a portion of the collection of radio heatmap values including the altered or generated at least one radio heatmap value to a mobile station as positioning assistance information.

In yet other implementations, an article may comprise: a non-transitory storage medium comprising machine-readable instructions stored thereon that are executable by a special purpose computing device to: alter or generate at least one radio heatmap value in a collection of radio heatmap values, the altering or generating based, at least in part, on a measurement of one or more characteristics of wireless signals received by a receiver at a first wireless network access point and transmitted by a transmitter at a second wireless network access point; and transmit at least a portion of the collection of radio heatmap values including the altered or generated at least one radio heatmap value to a mobile station as positioning assistance information.

In still other implementations, a method at a first wireless network access point may comprise: obtaining measurements of one or more characteristics of at least one wireless signal transmitted by a transmitter of a second wireless network access point; and transmitting the measurements to a server for use in altering or generating at least one radio heatmap value in a collection of radio heatmap values to be provided to a mobile station as positioning assistance information.

In still other implementations, an apparatus for collecting heatmap information may comprise: means for obtaining measurements of one or more characteristics of at least one wireless signal transmitted by a transmitter of a second wireless network access point; and means for transmitting the measurements to a server for use in altering or generating at least one radio heatmap value in a collection of radio heatmap values to be provided to a mobile station as positioning assistance information.

In still other implementations, an apparatus for collecting heatmap information may comprise: a non-transitory storage medium and one or more processing units to: obtain measurements of one or more characteristics of at least one wireless signal transmitted by a transmitter of a second wireless network access point. The apparatus may also comprise a wireless transceiver to: transmit the measurements to a server for use in altering or generating at least one radio heatmap value in a collection of radio heatmap values to be provided to a mobile station as positioning assistance information.

In still other implementations, an article may comprise: a non-transitory storage medium comprising machine-readable instructions stored thereon that are executable by a special purpose computing device to: obtain measurements of one or more characteristics of at least one wireless signal transmitted by a transmitter of a second wireless network access point; and transmit the measurements to a server for use in altering or generating at least one radio heatmap value in a collection of radio heatmap values to be provided to a mobile station as positioning assistance information.

### DETAILED DESCRIPTION

Reference throughout this specification to “one example”, “one feature”, “an example” or “one feature” means that a particular feature, structure, or characteristic described in connection with the feature and/or example is included in at least one feature and/or example of claimed subject matter. Thus, the appearances of the phrase “in one example”, “an example”, “in one feature”, or “a feature” in various places throughout this specification are not necessarily all referring to the same feature and/or example. Furthermore, the particular features, structures, or characteristics may be combined in one or more examples and/or features.

Various techniques are described herein which may be implemented in one or more land-based computing platforms or a mobile station (MS) to use inter-access point (inter-AP) measurements to generate or augment a heatmap. A heatmap, for example, may comprise positioning assistance information to enable an MS to determine its position, as explained below. An access point (AP) may comprise a land-based wireless transmitter that allows an MS, among other wireless devices, to connect to a wired network using Wi-Fi, Bluetooth, or any of a number of other standards, for example. In one implementation, an AP may comprise a personal area network transceiver such as Bluetooth or Zigbee transceivers, for example. In another implementation, an AP may comprise a femto cell, and both terms “AP” and “femto cell” may be used interchangeably unless otherwise indicated. In still another implementation, an AP may comprise a wireless network access point, and both terms “AP” and “wireless network access point” may be used interchangeably unless otherwise indicated wireless network access point. For example, a wireless network access point may comprise a network access point to allow one or more MSs to access wireless services, though claimed subject matter is not limited in this respect. A plurality of APs may be placed in a variety of known locations in an area such as an office building, shopping mall, suburban or urban area, and so on.

Inter-AP measurements may comprise measurements performed by an AP of received signal strength indicator (RSSI) or round trip time (RTT) of transmissions from other APs. RSSI or RTT values of a received transmission signal may comprise parameters that correspond to signal loss and may indicate a distance traveled by the transmission signal. For example, RSSI may decrease as the travel distance of a signal increases. RSSI may comprise the difference between transmitted signal strength and signal loss. In another example, RTT may increase as the travel distance of a signal increases. In some cases, one or more propagation parameters may be used to predict or infer, at least in part, signal loss over distance. Such signal loss, for example, may comprise exponential or linear signal degradation, though claimed subject matter is not so limited. Measurements of RSSI or RTT by a plurality of APs at a number of locations in an area may allow for generation or modification of a heatmap for that area. A heatmap may comprise a collection of heatmap values corresponding to expected measurements of RSSI or RTT at particular locations represented by the heatmap. For example, a heatmap may comprise heatmap values individually corresponding to particular points or relatively small areas of a region represented by a map of the region. Such a map may comprise a plurality of electronic signals representative of physical locations of a region and expected measurements of RSSI or RTT for the physical locations. In a particular example, an RSSI heatmap of a shopping mall may comprise a map of the shopping mall including expected RSSI measurements for various locations of the shopping mall. Not all locations represented by a heatmap, e.g., a shopping mall, may include expected RSSI or RTT measurements. For example, expected RSSI or RTT measurements may be available only at a number of APs and perhaps a few other locations. However, propagation parameters may be used to predict or infer RSSI or RTT for locations between or among APs to allow for relatively accurate generation or relatively precise modification of a heatmap.

In some implementations, an MS may receive navigation assistance data from a navigation system (e.g., located at a land-based server) as the MS enters a particular area. Such navigation assistance data may comprise a digital electronic map, for example. A navigation system may comprise an indoor navigation application, which may include one or more maps to show features of indoor structures such as doors, hallways, entry ways, walls, or points of interest (e.g., bathrooms, pay phones, room names, stores). Navigation assistance data may further include, for example, a heatmap to facilitate measurements of ranges to wireless access points positioned at known locations. As mentioned above, a heatmap may comprise information indicating, for a location on a map, expected RSSI or RTT associated with particular APs among a plurality of APs. Accordingly, by obtaining and displaying a digital electronic map, and by determining a current location by measuring RSSI or RTT and using a heatmap, an MS may overlay the current location of the MS on the displayed map, for example. A digital electronic map or a heatmap may be stored at a server to be accessible by an MS through selection of a URL, for example.

Inter-AP measurements may be used for any of a number of purposes. For example, APs may measure RSSI or RTT of transmissions by other APs in a process of improving transmission signal coverage or by reducing interference by adjusting transmission power of individual APs to “balance” transmission signal strength among the APs in a system or region. In an implementation, a navigation system may receive RSSI or RTT measurements (e.g., inter-AP measurements) from individual APs and use such information to generate or modify a heatmap. A navigation system may also receive estimates of locations of individual APs. For example, individual APs may transmit their estimated location to a navigation system from time to time or such an estimated location may accompany other data included in messages transmitted by an AP. An AP may also transmit an identifier to identify the AP performing the transmitting, though claimed subject matter is not so limited.

In one implementation, inter-AP measurements may allow for determination of one or more propagation parameters that may help to describe or to predict, at least in part, signal loss over distance, for example. Accordingly, one or more propagation parameters may then be used to estimate or determine expected RSSI values for locations between or among locations where RSSI is known. For example, inter-AP measurements may comprise RSSI or RTT measurements at locations of respective APs. In another example, inter-AP measurements may comprise RSSI or RTT measurements at locations along a line segment connecting APs. Thus, propagation parameters may facilitate a determination of expected RSSI or RTT values at locations in regions between or among respective APs. Accordingly, expected RSSI or RTT values may be determined for any of a number of locations in an area, in addition to measured RSSI or RTT values a priori known at the APs. Inter-AP measurements may involve a relatively small number of points (e.g., at the location of individual access points) that may be sampled or measured. Accordingly, propagation parameters may provide a technique to mathematically predict, at least in part, signal loss over distance, for example, for a plurality of points other than where APs may be located.

In an implementation, at least one radio heatmap value in a collection of radio heatmap values may be altered or generated based, at least in part, on inter-AP measurements. For example, a measurement of one or more characteristics of wireless signals received at a first AP at a first known location and transmitted by a second AP at a second known location may be used to alter or generate one or more radio heatmap values. One or more characteristics of wireless signals may comprise RSSI or RTT, for example. In one application, a collection of heatmap values, including altered or newly generated heatmap values, may be transmitted to an MS as positioning assistance information. For example, an MS may use heatmap values to determine its location. In another application, a collection of heatmap values, including altered or newly generated heatmap values, may be used at a land-based server to generate or modify a heatmap maintained at a local memory of the server.

In an implementation, a process for altering or generating at least one radio heatmap value may comprise determining a range between a first AP and a second AP. Such a range may be determined based, at least in part, on known locations of the first and second APs, for example. At least one propagation parameter may be derived based, at least in part, on a measured RSSI or RTT and a determined range. In another implementation, however, at least one propagation parameter may be derived based, at least in part, on a measured AP processing delay, as explained below, and a determined range. Such propagation parameters may then be used to alter or generate at least one radio heatmap value. In one example, a propagation parameter may comprise a value representative of signal strength loss per distance for a signal transmitted by an AP. In another example, a propagation parameter may comprise a value representative of transmission power of an AP. In yet another example, a propagation parameter may comprise a value representative of a transmission or receiving processing delay of an AP, as explained below. For example, assuming that a distance between a first AP and a second AP is 20 feet, and an RTT measurement between the first and second AP is 16540 nanoseconds (approximating that one nanosecond corresponds to about 1 feet). Then processing delay may be about 16500 nanoseconds (16540−20×2). On the other hand, a processing delay may be a priori known. For example, if the processing delay is 16500 nanoseconds and if the distance between the first and second AP is 40 feet, then a multi-path environment may be inferred if a measurement is 16600 nanoseconds (e.g., an additional 100 nanoseconds), which may account for an additional 10 feet of distance. Similarly, for RSSI, propagation parameters may be predicted if unknown or may be used for range measurements and adjustments if known relatively precisely.

In another implementation, a process for altering or generating at least one radio heatmap value may comprise determining separation distances between or among first, second, third, and other APs. At least one propagation parameter may be derived based, at least in part, on a measured RSSI or RTT and determined ranges among the APs. Such propagation parameters may then be used to alter or generate at least one radio heatmap value, in a process similar to that described above, for example.

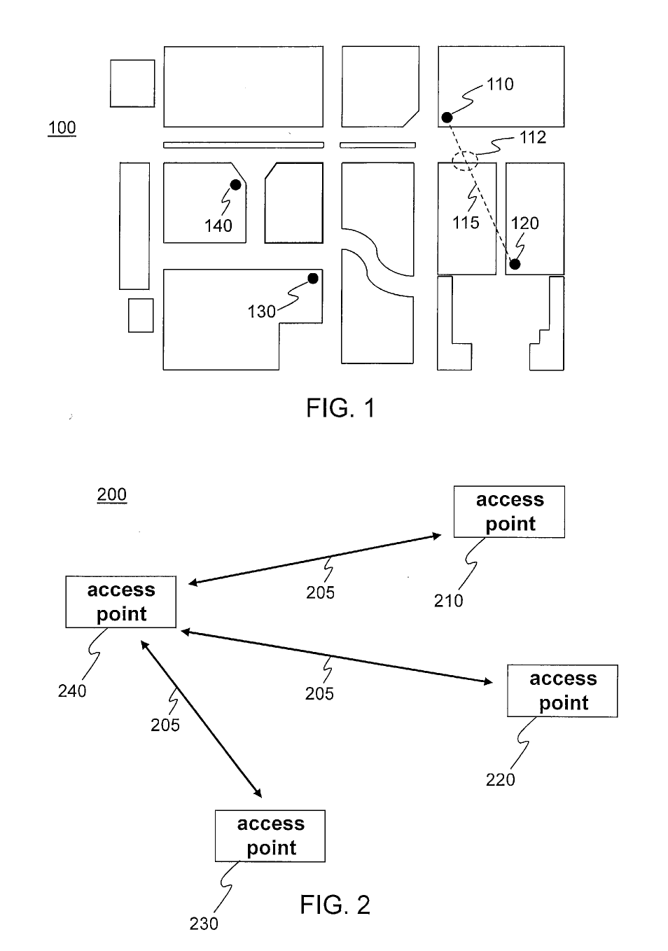

FIG. 1 shows a map of a building complex 100 that includes a number of APs, according to an implementation. In one implementation, building complex 100 may comprise an indoor corridor with rooms and walls, for example. In another implementation, building complex 100 may comprise a number of buildings. APs 110, 120, 130, and 140 may be placed at known locations in such a number of buildings. Building complex 100 may comprise an office building, shopping mall, suburban or urban area, and so on. As mentioned above, inter-AP measurements may comprise RSSI or RTT measurements obtained at an AP based, at least in part, on transmissions received by the AP originating at other APs. For example, AP 110 may receive a signal transmitted by AP 120. Accordingly, AP 110 may measure RSSI of the signal transmitted by AP 120. As another example, AP 140 may receive a signal transmitted by AP 110. Accordingly, AP 140 may measure RSSI of the signal transmitted by AP 110. In one implementation, inter-AP measurements may allow for determination of one or more propagation parameters that help to describe or to predict, at least in part, signal loss over distance. Thus, for example, propagation parameters may facilitate a determination of expected RSSI or RTT values for locations between or among respective APs. Such expected RSSI or RTT values may be used to populate or generate a heatmap. As an example, while inter-AP measurements may comprise RSSI or RTT values at AP 110 and AP 120, propagation parameters may facilitate a determination of expected RSSI or RTT values at any point along line 115. In other words, propagation parameters may be used in a process of interpolating values of RSSI or RTT measured at AP 110 and AP 120 to estimate or determine expected RSSI or RTT values for any point between AP 110 and AP 120. The term “interpolation” is not intended to imply a linear process: an interpolation process may involve nonlinear processes. Such a process of interpolation to estimate or determine expected RSSI or RTT values for any point along a line may be performed between other AP pairs, such as between AP 110 and AP 140, AP 110 and AP 130, AP 130 and AP 140, and so on. As explained in further detail below, propagation parameters may also be used to estimate or determine expected RSSI or RTT values for any location (e.g., in addition to lines between AP pairs) among APs. In other words, a technique for interpolating expected RSSI or RTT values for points along a line connecting the two APs may be expanded to extrapolating expected RSSI or RTT values for points beyond a line connecting the two APs. Determining expected RSSI values for locations between or among APs in a region may be useful for generating or modifying a heatmap for the region.

In the following numerical example, propagation parameters may be used in a process of interpolating RSSI values measured at AP 110 and AP 120 to determine expected RSSI or RTT values for any point between AP 110 and AP 120. Referring to FIG. 1, AP 110 measures −83.0 dBm (decibels) for an RSSI of a signal transmitted from AP 120. AP 110 and AP 120 are 31 meters apart (e.g., a length of line 115). At a distance of 1.0 meters from AP 120, an expected RSSI may be determined by subtracting near-field propagation loss from transmission power of AP 120. Near-field propagation loss at an AP transmission frequency of 2.4 GHz may be about 40.0 dBm, and AP transmission power at 15.0 mW may be about 17.0 dBm, for example. Thus, at a distance of 1.0 meters from AP 120, an expected RSSI may be about −23.0 dBm (e.g., a difference between 40.0 dBm and 17.0 dBm). There may be further loss of 60.0 dB over 30.0 meters along line 115. Assuming a linear model (while expressing values in dB), there may be a 2.0 dB loss per meter along line 115. Thus, for example, RSSI at 21.0 meters from AP 120 may be about −63.0 dBm.

Continuing the above numerical example, a wall of unknown penetration loss is now considered to be present at 112 along line 115. Based, at least in part, on inter-AP measurements in this case, a 1.5 dB per meter propagation loss along line 115 on either side of the wall may be inferred. Accordingly, wall loss X may satisfy a relation (X+30.0 meters*1.5 dB/meter=60.0 dB). Evaluating this relation may give X=15.0 db (e.g., wall loss is 15.0 dB). Wall loss is discussed in further detail below. Of course, such examples merely illustrate an aspect of a particular implementation, and claimed subject matter is not so limited.

FIG. 2 is a schematic block diagram of an access point system 200, according to an implementation. For example, as shown in the embodiment of FIG. 1, a plurality of APs may be placed in a variety of known locations in an area such as an office building, shopping mall, suburban or urban area, and so on. APs 210, 220, 230, and 240 may communicate with one another along wireless signal paths 205, for example. Though four APs are shown in system 200, claimed subject matter is not limited to any particular number of APs in a system. Inter-AP measurements may comprise RSSI or RTT measurements performed by an AP of transmissions from other APs. Measurements of RSSI or RTT by a plurality of APs at a number of locations in an area may allow for generation of a heatmap for that area or modification (e.g., a correction or addition) of an existing heatmap.

In an implementation, inter-AP measurements for n APs may comprise n(n−1) RSSI measurements. For an AP system, such as system 200 for example, inter-AP measurements may comprise twelve measurements, listed as follows: RSSI measurements performed by AP 210 of signals transmitted by AP 220; RSSI measurements performed by AP 220 of signals transmitted by AP 210; RSSI measurements performed by AP 210 of signals transmitted by AP 230; RSSI measurements performed by AP 230 of signals transmitted by AP 210; RSSI measurements performed by AP 210 of signals transmitted by AP 240; RSSI measurements performed by AP 240 of signals transmitted by AP 210; RSSI measurements performed by AP 220 of signals transmitted by AP 230; RSSI measurements performed by AP 230 of signals transmitted by AP 220; RSSI measurements performed by AP 220 of signals transmitted by AP 240; RSSI measurements performed by AP 240 of signals transmitted by AP 220; RSSI measurements performed by AP 230 of signals transmitted by AP 240; and RSSI measurements performed by AP 240 of signals transmitted by AP 230. In an implementation, such inter-AP measurements for a system 200 of APs may be used to generate or modify a heatmap for an area that includes system 200. Again, though system 200 is described as having four APs, a system of APs may have any number of APs, and claimed subject matter is not limited in this respect. A process of using inter-AP measurements to generate or modify a heatmap for system 200 of APs is described below, for example, for any number of APs.

As discussed above, propagation parameters may be used in a process of interpolating values of RSSI or RTT measured at AP pairs to estimate or determine expected RSSI or RTT values for any point along a line between the AP pairs. A technique of such interpolation may involve approximating signal loss of transmission by an AP, for example. In an implementation, a propagation parameter may be determined from such an approximated signal loss. For example, signal-loss at a particular location may be defined as

signal-loss=SL=(power transmitted by an AP)−RSSI,

where RSSI=a value of RSSI measured at the particular location. In some implementations, signal-loss of a signal transmitted by an AP at a distance d from the AP may be expressed by the relation

SL=40.0+α log(d) Eqn (1)

where α=propagation parameter and the number 40.0 represents near-field signal-loss of the transmitted signal relatively close (e.g., within about one meter) to the AP. Thus, using Eqn. 1, signal-loss of a signal may be determined at any distance d from an AP if propagation parameter α is known. Inter-AP measurements of a pair of APs may, in one implementation, be used to determine a propagation parameter a for a case where Eqn. 1 expresses signal-loss at any location along a line connecting the pair of APs. Such may be the case if the separation distance between the APs and the transmitted signal strength of the APs is known. For example, inter-AP measurements may comprise RSSI measured at a first AP of a signal transmitted by a second AP. Signal-loss of the signal transmitted by the second AP and received at the first AP may be determined based, at least in part, on the measured RSSI, since the separation distance of the first and second APs is known. Thus, once a has been determined, Eqn. 1 may be used to approximate signal-loss for any distance d from either AP of the AP pair.

In the example implementation described above, signal-loss at any location on a line connecting a pair of APs may be determined using Eqn. 1 to estimate or determine a value of RSSI for that location. In another implementation, signal-loss may be determined at any location among more than two APs using the following relation:

α*=arg minΣ[SLᵢⱼ−(40+αᵢⱼ log dᵢⱼ)]², Eqn (2)

where α*=minimum mean square propagation parameter for a system of two or more APs, SLᵢⱼ=signal loss matrix, αᵢⱼ=propagation parameter for the AP-pair APᵢ and APⱼ, and dᵢⱼ=separation distance between the AP-pair APᵢ and APⱼ. Eqn. 2 may be based, at least in part, on signal-loss between an ith access point AP; and a jth access point APⱼ and a linear combination of an ith propagation parameter αᵢ corresponding to APᵢ and a jth propagation parameter αⱼ corresponding to APⱼ. For n APs, there may be n(n−1) measurements between various combinations of AP pairs. Eqn. 2 may be used to estimate distances from a location (e.g., where an MS may be located) among a system of two or more APs to any particular AP. For example, if signal-loss SL between a particular location of an MS and a particular APj is SL_{MS-j} then an estimated distance may be expressed as d_{MS-j}=exp(SL−40)/α*, which may be used to estimate a location of the MS. Thus, instead of a single propagation parameter for a location between a pair of APs, as in the former example above, a multi-parameter model may be used for any location among two or more APs. Of course, such details of Eqns. 1 and 2 are merely examples, and claimed subject matter is not limited in this respect.

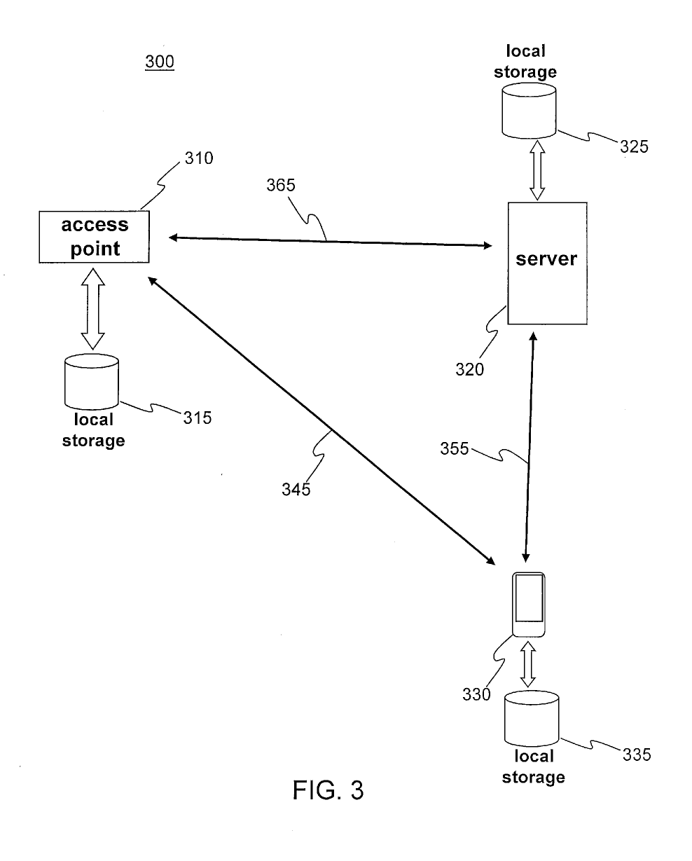

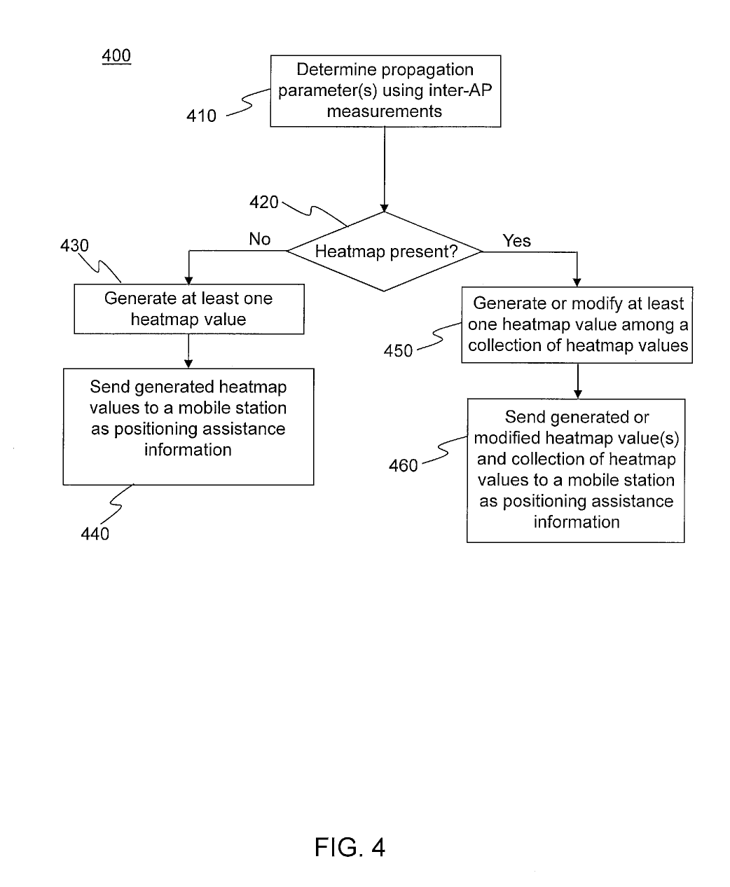

FIG. 3 is a schematic block diagram of a communication and computing system 300, according to an implementation. An access point AP 310 may comprise a land-based wireless transmitter that may allow MS 330, for example, to connect to a wired network server 320 via wireless signal path 345 and 365, which may be wired or wireless. MS 330 may also connect to server 320 via wireless signal path 355. As described in the example implementation shown in FIG. 2, AP 310 may comprise one of a plurality of APs, which may be placed in a variety of known locations in an area such as an office building, shopping mall, suburban or urban area, and so on. In some implementations, MS 330 may receive navigation assistance data from server 320 as the MS enters a particular area. For example, such navigation assistance data may comprise a heatmap or digital electronic map that may be maintained in local storage 325 of server 320. Such a heatmap, digital electronic map, or other navigation assistance data may also be stored in local storage 335 of MS 330.

As mentioned above, an AP, such as 310, may measure RSSI of transmissions by other APs. Such measured RSSI may be stored in a local storage 315 of AP 310, for example. However, in some implementations, measured RSSI may be sent to server 320 or MS 330 and need not be stored at AP 310. In an implementation, a navigation system (e.g., a portion of which may comprise an executable application) at server 320 or MS 330 may receive RSSI or RTT information from individual APs and use such information to generate or modify a heatmap stored at server 320 or MS 330. A navigation system may also receive, or already include, location information of individual APs. For example, AP 310 may send its location information to server 320 or MS 330 from time to time.

FIG. 4 is a flow diagram illustrating a process 400 for utilizing access point measurements to generate or modify a heatmap for a region, according to an implementation. Such a region may comprise a shopping mall, downtown area, or any area that includes a number of APs, for example. Process 400 may be performed at a server, such as network server 320, for example. At block 410, one or more propagation parameters may be determined using inter-AP measurements. For example, inter-AP measurements may allow for determination of one or more propagation parameters that describe, at least in part, signal loss over distance or RSSI, for example. A technique for determining propagation parameters using inter-AP measurements may involve using Eqns. 1 or 2 as described above, for example. At diamond 420, a determination may be made as to whether a heatmap is present or not. For example, a heatmap based, at least in part, on previously-measured RSSI values may be stored in a server such as 320. On the other hand, if a heatmap is not present, process 400 may proceed to block 430 where at least one heatmap value may be generated using inter-AP measurements and Eqns. 1 or 2, for example. At block 440, one or more generated heatmap values may be sent to an MS as positioning assistance information. For example, an MS may use heatmap values to determine its location.

Returning to diamond 420, if a heatmap is present, process 400 may proceed to block 450 where at least one heatmap value may be generated or modified using inter-AP measurements and Eqns. 1 or 2, for example. At block 460, a collection of heatmap values, including modified or newly generated heatmap values, may be sent to an MS as positioning assistance information. For example, an MS may use heatmap values to determine its location. Of course, such details of process 400 are merely examples, and claimed subject matter is not so limited.

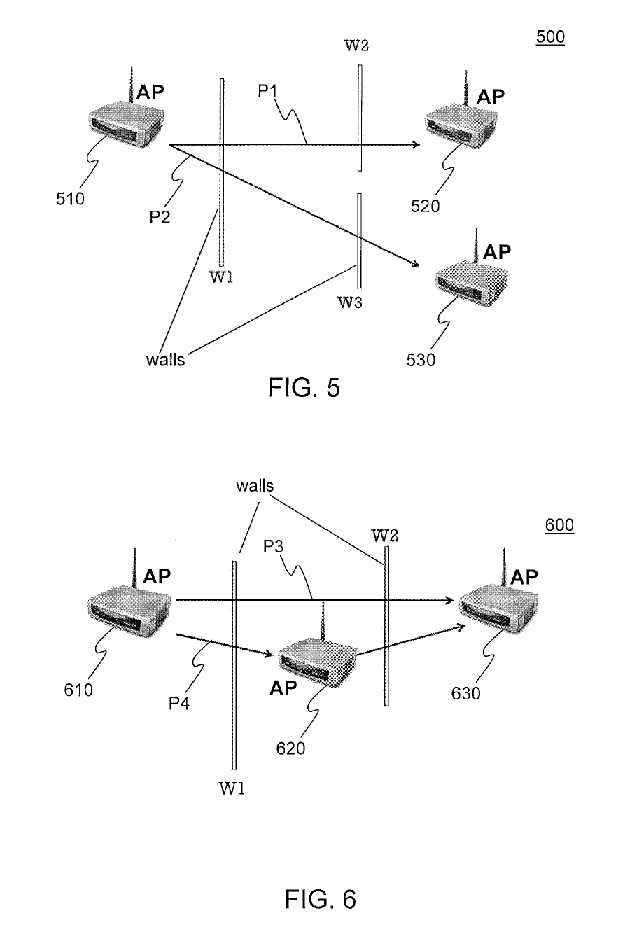

FIGS. 5 and 6 show access points separated by walls or other barriers of a building complex, according to an implementation. For example, in the example implementation 500 shown in FIG. 5, walls W1, W2, and W3 may be located between AP 510 and both AP 520 and AP 530. Such walls may attenuate a signal transmitted by an AP as signal energy travels through the walls. In other words, signal loss may occur as a signal travels through a wall. For example, a signal transmitted by AP 510 may be attenuated by walls W1, W2, and W3. An amount of attenuation (which may be linear or nonlinear for RSSI or RSS, for example) may be different for different walls so that attenuation by wall W1 need not be the same as attenuation by wall W2 or W3, and so on. For example, walls may comprise any of a number of materials that may attenuate a signal by various amounts. A wall may comprise drywall, concrete, brick, wood or metal framing, insulation, just to name a few examples. Moreover, walls may have various thicknesses to affect signal attenuation.

In an implementation, an attenuation inference technique may be used to determine which portion of a region (e.g., which wall(s)) may be at least partially responsible for a particular amount of signal loss. As explained above, expected RSSI values may be estimated or determined using propagation parameters. Furthermore, such propagation parameters may be determined from an approximated signal loss (e.g., such as by a signal's travel distance through air or walls, and so on). Accordingly, inferring location or number of walls along particular paths in a region may facilitate approximating signal loss along the particular paths. Thus, an attenuation inference technique may allow for estimating or determining expected RSSI values that may be affected by the presence of walls.

Such a technique may use multiple RSSI measurements. To illustrate a particular example, AP 520 and AP 530 may both measure RSSI of a signal transmitted by AP 510. However, AP 520 may measure RSSI of a signal transmitted by AP 510 along path P1 while AP 530 may measure RSSI of a signal transmitted by AP 510 along path P2. Differences in RSSI values measured at AP 520 and AP 530 may correspond to differences in features affecting signal propagation along paths P1 and P2. Such features of a path may comprise path length, number of walls along a path, thicknesses or materials of walls in the path, among other things. As shown in FIG. 5, wall W1 is common to both paths P1 and P2. However, wall W2 is not in path P2 and wall W3 is not in path P1. Thus, if RSSI measured at AP 520 is different from RSSI measured at AP 530, then such a difference may be attributable, at least in part, to characteristics of wall W2 or wall W3. For example, if RSSI measured at AP 520 is less than RSSI measured at AP 530, then an inference may be made that wall W2 attenuates a signal by a greater amount than that of wall W3. Of course, a difference of measured RSSI at AP 520 and at AP 530 may be attributable, at least in part, to difference in path length between P1 and P2. But such a path length difference may be accounted for so that its effect on attenuation may be distinguished from attenuation by other path characteristics (e.g., walls) if locations of AP 510, 520, and 530 are known.

For another example of an attenuation inference technique, AP 630 may measure RSSI of a signal transmitted by AP 610 along a first path P3 and AP 620 may measure RSSI of a signal transmitted by AP 610 along a path P4. Differences in RSSI measured at AP 620 and AP 630 may correspond to differences in features of paths P3 and P4. Wall W1 is common to both paths P3 and P4. However, wall W2 is not in path P4. Thus, if RSSI measured at AP 620 is different from RSSI measured at AP 630, then such a difference may be attributable, at least in part, to characteristics of wall W2. For example, if RSSI measured at AP 620 is less than RSSI measured at AP 630, then an inference may be made about the existence of wall W2. Again, a difference of measured RSSI at AP 620 and at AP 630 may be attributable, at least in part, to difference in path length between P3 and P4. But such a path length difference may be accounted for, as explained above.

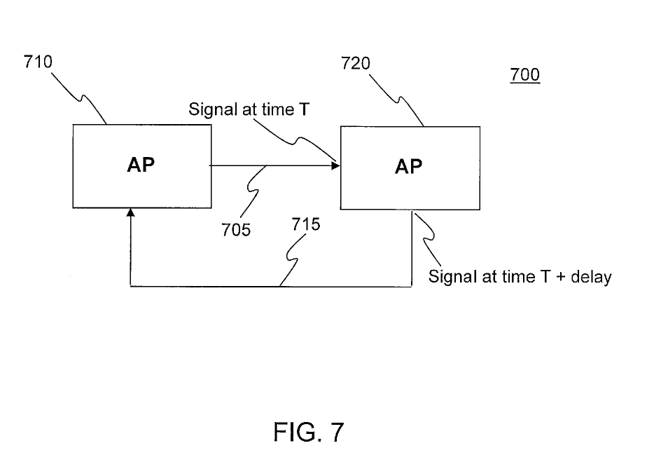

FIG. 7 shows a schematic block diagram of an access point system, including AP 720 to receive and transmit a signal, according to an implementation. In particular, RTT of a signal 705 transmitted by AP 710 may be received and re-transmitted by AP 720 as signal 715. AP 710 may then receive signal 715 comprising originally-transmitted signal 705 delayed by a round-trip time RTT. An additional delay may also be present: There may be a processing delay comprising a time difference between the time AP 720 receives signal 705 and the time AP 720 re-transmits the signal 715. Such processing delays for a plurality of APs may be expressed by the relation

RTTᵢⱼ/2=(T_{Rx-PROC}+T_{TX-PROC})+γdᵢⱼ Eqn (3)

where RTTᵢⱼ=round-trip time between an AP; and an APⱼ, T_{TX-PROC}=transmission processing delay of APᵢ and APⱼ, T_{RX-PROC}=receiving processing delay of APᵢ and AP_{j, γ}=distance ranging coefficient, and dᵢⱼ=distance between APᵢ and APⱼ.

Eqn. 3 may be valid for a model in which a plurality of APs have a common transmission processing delay T_{Tx-PROC} and a common receiving processing delay T_{Rx-PROC}+T_{TX-PROC}. For each pair of access points APᵢ and APⱼ, Eqn. 3 may be used to determine distance ranging coefficient value γ as well as a combined processing delay (T_{Rx-PROC}+T_{RX-PROC}), for example. Eqn. 3 may be extended to include APs with different processing delays by, for example, summing Eqn. 3 for individual pairs of APs. Eqn. 3 may be used to estimate distances from a location (e.g., where an MS may be located) among a system of two or more APs to any particular AP. For example, if RTT between a particular location of an MS and a particular APj is RTT_{MS-j} then an estimated distance may be expressed as

d_{MS-j}=(1/γ)[(RTTᵢⱼ/2)−(T_{Rx-PROC}+T_{TX-PROC})] Eqn. (4)

which may be used to estimate a location of the MS. Of course, such details of Eqns. 3 and 4 are merely examples of estimating distances, and claimed subject matter is not limited in this respect.

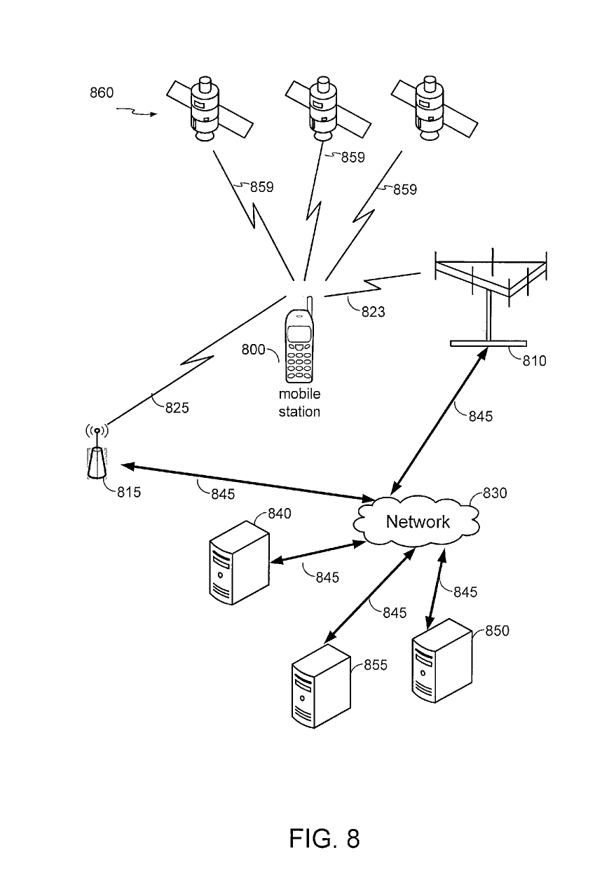

In certain implementations, as shown in FIG. 8, an MS 800 may receive or acquire SPS signals 859 from SPS satellites 860. In some embodiments, SPS satellites 860 may be from one global navigation satellite system (GNSS), such as the GPS or Galileo satellite systems. In other embodiments, the SPS Satellites may be from multiple GNSS such as, but not limited to, GPS, Galileo, Glonass, or Beidou (Compass) satellite systems. In other embodiments, SPS satellites may be from any one several regional navigation satellite systems (RNSS′) such as, for example, WAAS, EGNOS, QZSS, just to name a few examples.

In addition, the MS 800 may transmit radio signals to, and receive radio signals from, a wireless communication network. In one example, MS 800 may communicate with a cellular communication network by transmitting wireless signals to, or receiving wireless signals from, a base station transceiver 810 over a wireless communication link 823. Similarly, MS 800 may transmit wireless signals to, or receiving wireless signals from a local transceiver 815 over a wireless communication link 825.

In a particular implementation, local transceiver 815 may be configured to communicate with MS 800 at a shorter range over wireless communication link 823 than at a range enabled by base station transceiver 810 over wireless communication link 823. For example, local transceiver 815 may be positioned in an indoor environment. Local transceiver 815 may provide access to a wireless local area network (WLAN, e.g., IEEE Std. 802.11 network) or wireless personal area network (WPAN, e.g., Bluetooth network). In another example implementation, local transceiver 815 may comprise a femto cell transceiver capable of facilitating communication on link 825 according to a cellular communication protocol. Of course, it should be understood that these are merely examples of networks that may communicate with an MS over a wireless link, and claimed subject matter is not limited in this respect.

In a particular implementation, base station transceiver 810 and local transceiver 815 may communicate with servers 840, 850 and 855 over a network 830 through links 845. Here, network 830 may comprise any combination of wired or wireless links. In a particular implementation, network 830 may comprise Internet Protocol (IP) infrastructure capable of facilitating communication between MS 800 and servers 840, 850 or 855 through local transceiver 815 or base station transceiver 810. In another implementation, network 830 may comprising cellular communication network infrastructure such as, for example, a base station controller or master switching center to facilitate mobile cellular communication with MS 800.

In particular implementations, and as discussed below, MS 800 may have circuitry and processing resources capable of computing a position fix or estimated location of MS 800. For example, MS 800 may compute a position fix based, at least in part, on pseudorange measurements to four or more SPS satellites 860. Here, MS 800 may compute such pseudorange measurements based, at least in part, on pseudonoise code phase detections in signals 859 acquired from four or more SPS satellites 860. In particular implementations, MS 800 may receive from server 840, 850 or 855 positioning assistance data to aid in the acquisition of signals 859 transmitted by SPS satellites 860 including, for example, almanac, ephemeris data, Doppler search windows, just to name a few examples.

In other implementations, MS 800 may obtain a position fix by processing signals received from terrestrial transmitters fixed at known locations (e.g., such as base station transceiver 810) using any one of several techniques such as, for example, advanced forward trilateration (AFLT) and/or observed time difference of arrival (OTDOA). In these particular techniques, a range from MS 800 may be measured to three or more of such terrestrial transmitters fixed at known locations based, at least in part, on pilot signals transmitted by the transmitters fixed at known locations and received at MS 800. Here, servers 840, 850 or 855 may be capable of providing positioning assistance data to MS 800 including, for example, locations and identities of terrestrial transmitters to facilitate positioning techniques such as AFLT and OTDOA. For example, servers 840, 850 or 855 may include a base station almanac (BSA) which indicates locations and identities of cellular base stations in a particular region or regions.

In particular environments such as indoor environments or urban canyons, MS 800 may not be capable of acquiring signals 859 from a sufficient number of SPS satellites 860 or perform AFLT or OTDOA to compute a position fix. Alternatively, MS 800 may be capable of computing a position fix based, at least in part, on signals acquired from local transmitters (e.g., femto cells or WLAN access points positioned at known locations), such as access point 310 shown in FIG. 3. For example, MSs can typically obtain a position fix by measuring ranges to three or more indoor terrestrial wireless access points which are positioned at known locations, as shown in FIG. 2. Such ranges may be measured, for example, by obtaining a MAC ID address from signals received from such access points and obtaining range measurements to the access points by measuring one or more characteristics of signals received from such access points such as, for example, received signal strength (RSSI) or round trip time (RTT). In alternative implementations, MS 800 may obtain an indoor position fix by applying characteristics of acquired signals to a radio “heatmap” indicating expected RSSI and/or RTT signatures at particular locations in an indoor area.

In particular implementations, MS 800 may receive positioning assistance data for indoor positioning operations from servers 840, 850 or 855. For example, such positioning assistance data may include locations and identities of transmitters positioned at known locations to enable measuring ranges to these transmitters based, at least in part, on a measured RSSI and/or RTT, for example. Other positioning assistance data to aid indoor positioning operations may include radio heatmaps, locations and identities of transmitters, routeability graphs, just to name a few examples. Other assistance data received by the MS may include, for example, local maps of indoor areas for display or to aid in navigation. Such a map, which may comprise a conceptual map in some cases, for example, may be provided to MS 800 as MS 800 enters a particular indoor area. Such a map may show indoor features such as doors, hallways, entry ways, walls, etc., points of interest such as bathrooms, pay phones, room names, stores, etc. By obtaining and displaying such a map, an MS may overlay a current location of the MS (and user) over the displayed map to provide the user with additional context.

In one implementation, a routeability graph and/or digital map may assist MS 800 in defining feasible areas for navigation within an indoor area and subject to physical obstructions (e.g., walls) and passage ways (e.g., doorways in walls). Here, by defining feasible areas for navigation, MS 800 may apply constraints to aid in the application of filtering measurements for estimating locations and/or motion trajectories according to a motion model (e.g., according to a particle filter and/or Kalman filter). In addition to measurements obtained from the acquisition of signals from local transmitters, according to a particular embodiment, MS 800 may further apply a motion model to measurements or inferences obtained from inertial sensors (e.g., accelerometers, gyroscopes, magnetometers, etc.) and/or environment sensors (e.g., temperature sensors, microphones, barometric pressure sensors, ambient light sensors, camera imager, etc.) in estimating a location or motion state of MS 800.

According to an embodiment, MS 800 may access indoor navigation assistance data through servers 840, 850 or 855 by, for example, requesting the indoor assistance data through selection of a universal resource locator (URL). Servers 840, 850 or 855 may comprise one or more features of server 320 shown in FIG. 3, for example. In particular implementations, servers 840, 850 or 855 may be capable of providing indoor navigation assistance data to cover many different indoor areas including, for example, floors of buildings, wings of hospitals, terminals at an airport, portions of a university campus, areas of a large shopping mall, just to name a few examples. Also, memory resources at MS 800 and data transmission resources may make receipt of indoor navigation assistance data for all areas served by servers 840, 850 or 855 impractical or infeasible, a request for indoor navigation assistance data from MS 800 may indicate a rough or course estimate of a location of MS 800. MS 800 may then be provided indoor navigation assistance data covering areas including and/or proximate to the rough or course estimate of the location of MS 800.

In one particular implementation, a request for indoor navigation assistance data from MS 800 may specify a location context identifier (LCI). Such an LCI may be associated with a locally defined area such as, for example, a particular floor of a building or other indoor area which is not mapped according to a global coordinate system. In one example server architecture, upon entry of an area, MS 800 may request a first server, such as server 840, to provide one or more LCIs covering the area or adjacent areas. Here, the request from the MS 800 may include a rough location of MS 800 such that the requested server may associate the rough location with areas covered by known LCIs, and then transmit those LCIs to MS 800. MS 800 may then use the received LCIs in subsequent messages with a different server, such as server 850, for obtaining navigation assistance relevant to an area identifiable by one or more of the LCIs as discussed above (e.g., digital maps, locations and identifies of beacon transmitters, radio heatmaps or routeability graphs).

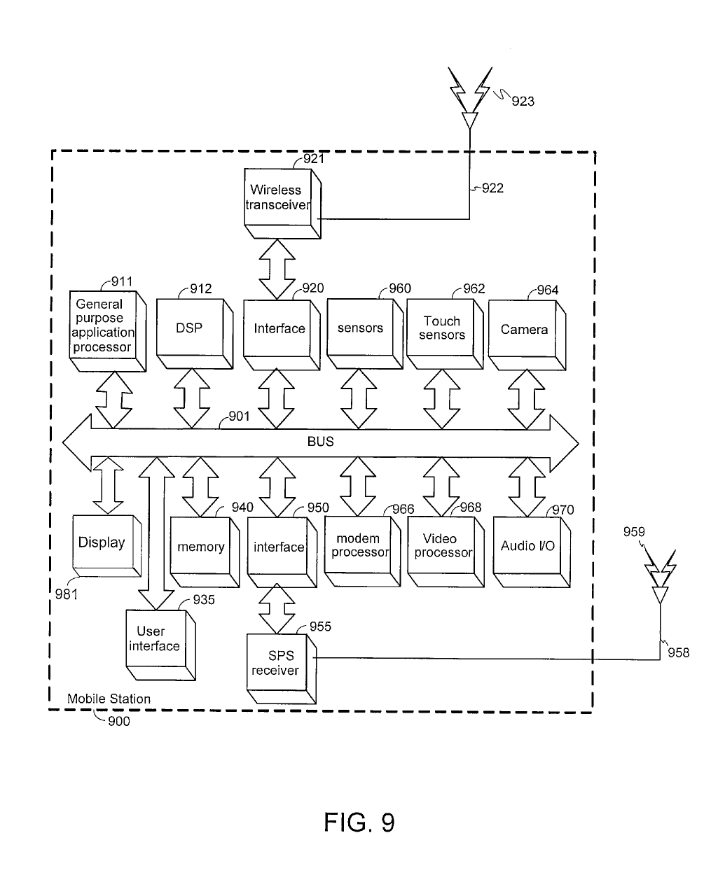

FIG. 9 is a schematic diagram of an MS according to an embodiment. MS 900 may comprise one or more features of MS 330 shown in FIG. 3 or MS 800 shown in FIG. 8, for example. In certain embodiments, MS 900 may also comprise a wireless transceiver 921 which is capable of transmitting and receiving wireless signals 923 via an antenna 922 over a wireless communication network, such as over a wireless communication link 823, shown in FIG. 8, for example. Wireless transceiver 921 may be connected to bus 901 by a wireless transceiver bus interface 920. Wireless transceiver bus interface 920 may, in some embodiments be at least partially integrated with wireless transceiver 921. Some embodiments may include multiple wireless transceivers 921 and wireless antennas 922 to enable transmitting and/or receiving signals according to a corresponding multiple wireless communication standards such as, for example, WiFi, CDMA, WCDMA, LTE and Bluetooth, just to name a few examples.

MS 900 may also comprise SPS receiver 955 capable of receiving and acquiring SPS signals 959 via SPS antenna 958. SPS receiver 955 may also process, in whole or in part, acquired SPS signals 959 for estimating a location of MS 1000. In some embodiments, general-purpose processor(s) 911, memory 940, DSP(s) 912 and/or specialized processors (not shown) may also be utilized to process acquired SPS signals, in whole or in part, and/or calculate an estimated location of MS 900, in conjunction with SPS receiver 955. Storage of SPS or other signals for use in performing positioning operations may be performed in memory 940 or registers (not shown).

Also shown in FIG. 9, MS 900 may comprise digital signal processor(s) (DSP(s)) 912 connected to the bus 901 by a bus interface 910, general-purpose processor(s) 911 connected to the bus 901 by a bus interface 910 and memory 940. Bus interface 910 may be integrated with the DSP(s) 912, general-purpose processor(s) 911 and memory 940. In various embodiments, functions or processes, such as process 400 shown in FIG. 4, for example, may be performed in response to execution of one or more machine-readable instructions stored in memory 940 such as on a computer-readable storage medium, such as RAM, ROM, FLASH, or disc drive, just to name a few example. The one or more instructions may be executable by general-purpose processor(s) 911, specialized processors, or DSP(s) 912. In one implementation, for example, one or more machine-readable instructions stored in memory 940 may be executable by a processor(s) 911 to: alter or generate at least one radio heatmap value in a collection of radio heatmap values, wherein the altering or generating may be based, at least in part, on a measurement of one or more characteristics of wireless signals received by a receiver at a first known location and transmitted by a transmitter at a second known location; and transmit at least a portion of the collection of radio heatmap values including the altered or generated at least one radio heatmap value to an MS as positioning assistance information. Memory 940 may comprise a non-transitory processor-readable memory and/or a computer-readable memory that stores software code (programming code, instructions, etc.) that are executable by processor(s) 911 and/or DSP(s) 912 to perform functions described herein.

Also shown in FIG. 9, a user interface 935 may comprise any one of several devices such as, for example, a speaker, microphone, display device, vibration device, keyboard, touch screen, just to name a few examples. In a particular implementation, user interface 935 may enable a user to interact with one or more applications hosted on MS 900. For example, devices of user interface 935 may store analog or digital signals on memory 940 to be further processed by DSP(s) 912 or general purpose processor 911 in response to action from a user. Similarly, applications hosted on MS 900 may store analog or digital signals on memory 940 to present an output signal to a user. In another implementation, MS 900 may optionally include a dedicated audio input/output (I/O) device 970 comprising, for example, a dedicated speaker, microphone, digital to analog circuitry, analog to digital circuitry, amplifiers and/or gain control. It should be understood, however, that this is merely an example of how an audio I/O may be implemented in an MS, and that claimed subject matter is not limited in this respect. In another implementation, MS 900 may comprise touch sensors 962 responsive to touching or pressure on a keyboard or touch screen device.

MS 900 may also comprise a dedicated camera device 964 for capturing still or moving imagery. Camera device 964 may be used as an environmental sensor, for example. Camera device 964 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose processor 911 or DSP(s) 912. Alternatively, a dedicated video processor 968 may perform conditioning, encoding, compression or manipulation of signals representing captured images. Additionally, video processor 968 may decode/decompress stored image data for presentation on a display device 981 on MS 900.

MS 900 may also comprise sensors 960 coupled to bus 901 which may include, for example, inertial sensors and environment sensors that may be used for ground-truth measurements, as described above. Inertial sensors of sensors 960 may comprise, for example accelerometers (e.g., collectively responding to acceleration of MS 900 in three dimensions), one or more gyroscopes or one or more magnetometers (e.g., to support one or more compass applications). Environment sensors of MS 900 may comprise, for example, temperature sensors, barometric pressure sensors, ambient light sensors, camera imagers, and microphones, just to name few examples. Sensors 960 may generate analog or digital signals that may be stored in memory 940 and processed by DPS(s) or general purpose processor 911 in support of one or more applications such as, for example, applications directed to positioning or navigation operations.

In a particular implementation, MS 900 may comprise a dedicated modem processor 966 capable of performing baseband processing of signals received and downconverted at wireless transceiver 921 or SPS receiver 955. Similarly, modem processor 966 may perform baseband processing of signals to be upconverted for transmission by wireless transceiver 921. In alternative implementations, instead of having a dedicated modem processor, baseband processing may be performed by a general purpose processor or DSP (e.g., general purpose processor 911 or DSP(s) 912). It should be understood, however, that these are merely examples of structures that may perform baseband processing, and that claimed subject matter is not limited in this respect.

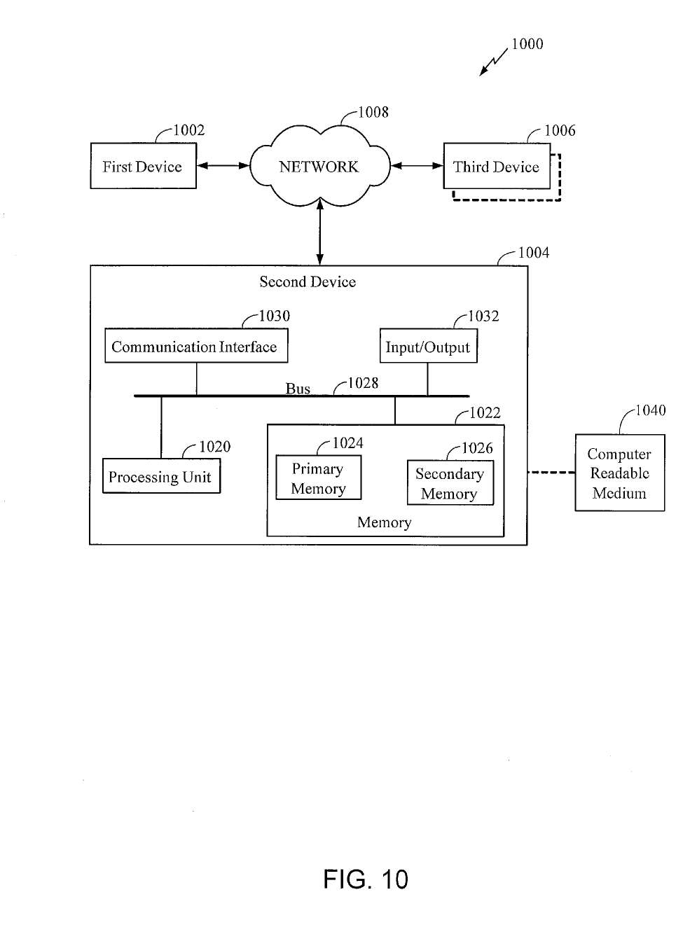

FIG. 10 is a schematic diagram illustrating an example system 1000 that may include one or more devices configurable to implement techniques or processes, such as process 1000 described above, for example, in connection with FIG. 8. System 1000 may include, for example, a first device 1002, a second device 1004, and a third device 1006, which may be operatively coupled together through a wireless communications network 1008. In an aspect, first device 1002 may comprise a server capable of providing positioning assistance data such as, for example, a base station almanac. First device 1002 may also comprise a server capable of providing an LCI to a requesting MS based, at least in part, on a rough estimate of a location of the requesting MS. First device 1002 may also comprise a server capable of providing indoor positioning assistance data relevant to a location of an LCI specified in a request from an MS. Second and third devices 1004 and 1006 may comprise MSs, in an aspect. Also, in an aspect, wireless communications network 1008 may comprise one or more wireless access points, for example. However, claimed subject matter is not limited in scope in these respects.

First device 1002, second device 1004 and third device 1006, as shown in FIG. 10, may be representative of any device, appliance or machine that may be configurable to exchange data over wireless communications network 1008. By way of example but not limitation, any of first device 1002, second device 1004, or third device 1006 may include: one or more computing devices or platforms, such as, e.g., a desktop computer, a laptop computer, a workstation, a server device, or the like; one or more personal computing or communication devices or appliances, such as, e.g., a personal digital assistant, mobile communication device, or the like; a computing system or associated service provider capability, such as, e.g., a database or data storage service provider/system, a network service provider/system, an Internet or intranet service provider/system, a portal or search engine service provider/system, a wireless communication service provider/system; or any combination thereof. Any of the first, second, and third devices 1002, 1004, and 1006, respectively, may comprise one or more of a base station almanac server, a base station, or an MS in accordance with the examples described herein.

Similarly, wireless communications network 1008, as shown in FIG. 10, is representative of one or more communication links, processes, or resources configurable to support the exchange of data between at least two of first device 1002, second device 1004, and third device 1006. By way of example but not limitation, wireless communications network 1008 may include wireless or wired communication links, telephone or telecommunications systems, data buses or channels, optical fibers, terrestrial or space vehicle resources, local area networks, wide area networks, intranets, the Internet, routers or switches, and the like, or any combination thereof. As illustrated, for example, by the dashed lined box illustrated as being partially obscured of third device 1006, there may be additional like devices operatively coupled to wireless communications network 1008.

It is recognized that all or part of the various devices and networks shown in system 1000, and the processes and methods as further described herein, may be implemented using or otherwise including hardware, firmware, software, or any combination thereof.

Thus, by way of example but not limitation, second device 1004 may include at least one processing unit 1020 that is operatively coupled to a memory 1022 through a bus 1028. In one implementation, for example, one or more machine-readable instructions stored in memory 1022 may be executable by processing unit 1020 to: receive a conceptual map of a navigable area, wherein the conceptual map may include two or more topological elements being related to one another in the conceptual map by a first set of dimensions; apply one or more ground truth measurements or topological constraints to the first set of dimensions of the conceptual map to provide a modified map having corrected dimensions; and map an estimated location of a mobile station to the modified map.

Processing unit 1020 is representative of one or more circuits configurable to perform at least a portion of a data computing procedure or process. By way of example but not limitation, processing unit 1020 may include one or more processors, controllers, microprocessors, microcontrollers, application specific integrated circuits, digital signal processors, programmable logic devices, field programmable gate arrays, and the like, or any combination thereof.

Memory 1022 is representative of any data storage mechanism. Memory 1022 may include, for example, a primary memory 1024 or a secondary memory 1026. Primary memory 1024 may include, for example, a random access memory, read only memory, etc. While illustrated in this example as being separate from processing unit 1020, it should be understood that all or part of primary memory 1024 may be provided within or otherwise co-located/coupled with processing unit 1020.

Secondary memory 1026 may include, for example, the same or similar type of memory as primary memory or one or more data storage devices or systems, such as, for example, a disk drive, an optical disc drive, a tape drive, a solid state memory drive, etc. In certain implementations, secondary memory 1026 may be operatively receptive of, or otherwise configurable to couple to, a computer-readable medium 1040. Computer-readable medium 1040 may include, for example, any non-transitory medium that can carry or make accessible data, code or instructions for one or more of the devices in system 1000. Computer-readable medium 1040 may also be referred to as a storage medium.

Second device 1004 may include, for example, a communication interface 1030 that provides for or otherwise supports the operative coupling of second device 1004 to at least wireless communications network 1008. By way of example but not limitation, communication interface 1030 may include a network interface device or card, a modem, a router, a switch, a transceiver, and the like.

Second device 1004 may include, for example, an input/output device 1032. Input/output device 1032 is representative of one or more devices or features that may be configurable to accept or otherwise introduce human or machine inputs, or one or more devices or features that may be configurable to deliver or otherwise provide for human or machine outputs. By way of example but not limitation, input/output device 1032 may include an operatively configured display, speaker, keyboard, mouse, trackball, touch screen, data port, etc.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the detailed description included herein are presented in terms of algorithms or symbolic representations of operations on binary digital signals stored within a memory of a specific apparatus or special purpose computing device or platform.

In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (“WWAN”), a wireless local area network (“WLAN”), a wireless personal area network (WPAN), and so on. The term “network” and “system” may be used interchangeably herein. A WWAN may be a Code Division Multiple Access (“CDMA”) network, a Time Division Multiple Access (“TDMA”) network, a Frequency Division Multiple Access (“FDMA”) network, an Orthogonal Frequency Division Multiple Access (“OFDMA”) network, a Single-Carrier Frequency Division Multiple Access (“SC-FDMA”) network, or any combination of the above networks, and so on. A CDMA network may implement one or more radio access technologies (“RATs”) such as cdma2000, Wideband-CDMA (“W-CDMA”), to name just a few radio technologies. Here, cdma2000 may include technologies implemented according to IS-95, IS-2000, and IS-856 standards. A TDMA network may implement Global System for Mobile Communications (“GSM”), Digital Advanced Mobile Phone System (“D-AMPS”), or some other RAT. GSM and W-CDMA are described in documents from a consortium named “3rd Generation Partnership Project” (“3GPP”). Cdma2000 is described in documents from a consortium named “3rd Generation Partnership Project 2” (“3GPP2”). 3GPP and 3GPP2 documents are publicly available. 4G Long Term Evolution (“LTE”) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femto cell, utilized to extend cellular telephone service into a business or home. In such an implementation, one or more MSs may communicate with a femto cell via a code division multiple access (“CDMA”) cellular communication protocol, for example, and the femto cell may provide the MS access to a larger cellular telecommunication network by way of another broadband network such as the Internet.

Techniques described herein may be used with an SPS that includes any one of several GNSS and/or combinations of GNSS. Furthermore, such techniques may be used with positioning systems that utilize terrestrial transmitters acting as “pseudolites”, or a combination of SVs and such terrestrial transmitters. Terrestrial transmitters may, for example, include ground-based transmitters that broadcast a PN code or other ranging code (e.g., similar to a GPS or CDMA cellular signal). Such a transmitter may be assigned a unique PN code so as to permit identification by a remote receiver. Terrestrial transmitters may be useful, for example, to augment an SPS in situations where SPS signals from an orbiting SV might be unavailable, such as in tunnels, mines, buildings, urban canyons or other enclosed areas. Another implementation of pseudolites is known as radio-beacons. The term “SV”, as used herein, is intended to include terrestrial transmitters acting as pseudolites, equivalents of pseudolites, and possibly others. The terms “SPS signals” and/or “SV signals”, as used herein, is intended to include SPS-like signals from terrestrial transmitters, including terrestrial transmitters acting as pseudolites or equivalents of pseudolites.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

1. A method for collecting heatmap information, the method comprising:
altering or generating at least one radio heatmap value in a collection of radio heatmap values, said altering or generating based, at least in part, on a measurement of one or more characteristics of wireless signals received by a receiver at a first wireless network access point and transmitted by a transmitter at a second wireless network access point; and
transmitting at least a portion of said collection of radio heatmap values including said altered or generated at least one radio heatmap value to a mobile station as positioning assistance information, wherein said at least one of said one or more characteristics comprises a received signal strength and wherein, said altering or generating the at least one radio heatmap value further comprises:
determining a range between said first and said second wireless network access points;
deriving at least one propagation parameter based, at least in part, on said received signal strength and the determined range; and
altering said at least one heatmap value based, at least in part, on said at least one propagation parameter.

2. (canceled)

3. The method of claim 1, wherein said at least one propagation parameter comprises a value representative of signal strength loss per distance.

4. The method of claim 1, wherein said at least one propagation parameter comprises a value representative of transmission power of said transmitter.

5. The method of claim 1, wherein said at least one propagation parameter comprises a value representative of a transmission processing delay of said transmitter.

6. The method of claim 1, wherein said at least one propagation parameter comprises a value representative of a receiving processing delay of said receiver.

7. (canceled)

8. A method for collecting heatmap information, the method comprising:
altering or generating at least one radio heatmap value in a collection of radio heatmap values, said altering or generating based, at least in part, on a measurement of one or more characteristics of wireless signals received by a receiver at a first wireless network access point and transmitted by a transmitter at a second wireless network access point; and
transmitting at least a portion of said collection of radio heatmap values including said altered or generated at least one radio heatmap value to a mobile station as positioning assistance information, wherein
at least one of said one or more characteristics comprises a processing delay, and wherein said altering said at least one radio heatmap value further comprises:
determining a range between said first and said second wireless network access points;
deriving at least one propagation parameter based, at least in part, on said processing delay and said determined range; and
altering said at least one radio heatmap value based, at least in part, on said at least one propagation parameter.

9. A method for collecting heatmap information, the method comprising:
altering or generating at least one radio heatmap value in a collection of radio heatmap values, said altering or generating based, at least in part, on a measurement of one or more characteristics of wireless signals received by a receiver at a first wireless network access point and transmitted by a transmitter at a second wireless network access point; and
transmitting at least a portion of said collection of radio heatmap values including said altered or generated at least one radio heatmap value to a mobile station as positioning assistance information;
determining ranges among said first and said second wireless network access points and a third wireless network access point;
deriving one or more propagation parameters based, at least in part, on a measurement of one or more characteristics of wireless signals received by said receiver and transmitted by a second transmitter at said third wireless network access point; and
altering said at least one heatmap value based, at least in part, on said one or more propagation parameters.

10. (canceled)

11. (canceled)

12. An apparatus for collecting heatmap information, the apparatus comprising:
means for altering or generating at least one radio heatmap value in a collection of radio heatmap values, said altering or generating based, at least in part, on a measurement of one or more characteristics of wireless signals received by a receiver at a first wireless network access point and transmitted by a transmitter at a second wireless network access point; and
means for transmitting at least a portion of said collection of radio heatmap values including said altered or generated at least one radio heatmap value to a mobile station as positioning assistance information wherein, at least one of said one or more characteristics comprises a received signal strength, and wherein said means for altering or generating said at least one radio heatmap value further comprises:
means for determining a range between said first and said second wireless network access points;
means for deriving at least one propagation parameter based, at least in part, on said received signal strength and said determined range; and
means for altering said at least one radio heatmap value based, at least in part, on said at least one propagation parameter.

13. (canceled)

14. The apparatus of claim 12, wherein said at least one propagation parameter comprises a value representative of signal strength loss per distance.

15. The apparatus of claim 12, wherein said at least one propagation parameter comprises a value representative of transmission power of said transmitter.

16. The apparatus of claim 12, wherein said at least one propagation parameter comprises a value representative of a transmission processing delay of said transmitter.

17. The apparatus of claim 12, wherein said at least one propagation parameter comprises a value representative of a receiving processing delay of said receiver.

18. (canceled)

19. An apparatus for collecting heatmap information, the apparatus comprising:
means for altering or generating at least one radio heatmap value in a collection of radio heatmap values, said altering or generating based, at least in part, on a measurement of one or more characteristics of wireless signals received by a receiver at a first wireless network access point and transmitted by a transmitter at a second wireless network access point; and
means for transmitting at least a portion of said collection of radio heatmap values including said altered or generated at least one radio heatmap value to a mobile station as positioning assistance information, wherein at least one of said one or more characteristics comprises a processing delay, and wherein said means for altering said at least one radio heatmap value further comprises:
means for determining a range between said first and said second wireless network access points;
means for deriving at least one propagation parameter based, at least in part, on said processing delay and said determined range; and
means for altering said at least one heatmap value based, at least in part, on said at least one propagation parameter.

20. An apparatus for collecting heatmap information, the apparatus comprising:
means for altering or generating at least one radio heatmap value in a collection of radio heatmap values, said altering or generating based, at least in part, on a measurement of one or more characteristics of wireless signals received by a receiver at a first wireless network access point and transmitted by a transmitter at a second wireless network access point; and
means for transmitting at least a portion of said collection of radio heatmap values including said altered or generated at least one radio heatmap value to a mobile station as positioning assistance information;
means for determining ranges among said first and said second wireless network access points and a third wireless network access point;
means for deriving one or more propagation parameters based, at least in part, on a measurement of one or more characteristics of wireless signals received by said receiver and transmitted by a second transmitter at said third wireless network access point; and
means for altering said at least one heatmap value based, at least in part, on said one or more propagation parameters.

21. (canceled)

22. (canceled)

23. An apparatus for collecting heatmap information, the apparatus comprising:
a non-transitory storage medium;
one or more processing units to:
alter or generate at least one radio heatmap value in a collection of radio heatmap values stored in said non-transitory storage medium, said altering or generating based, at least in part, on a measurement of one or more characteristics of wireless signals received by a receiver at a first wireless network access point and transmitted by a transmitter at a second wireless network access point, wherein at least one of said one or more characteristics comprises a received signal strength;
determine a range between said first and said second wireless network access points;
derive at least one propagation parameter based, at least in part, on said received signal strength and said determined range; and
alter said at least one heatmap value based, at least in part, on said at least one propagation parameter; and
a wireless transceiver to:
transmit at least a portion of said collection of radio heatmap values including said altered or generated at least one radio heatmap value to a mobile station as positioning assistance information.

24. (canceled)

25. The apparatus of claim 23, wherein said at least one propagation parameter comprises a value representative of signal strength loss per distance.

26. The apparatus of claim 23, wherein said at least one propagation parameter comprises a value representative of transmission power of said transmitter.

27. The apparatus of claim 23, wherein said at least one propagation parameter comprises a value representative of a transmission processing delay of said transmitter.

28. The apparatus of claim 23, wherein said at least one propagation parameter comprises a value representative of a receiving processing delay of said receiver.

29. (canceled)

30. An apparatus for collecting heatmap information, comprising:
a non-transitory storage medium;
one or more processing units to:
alter or generate at least one radio heatmap value in a collection of radio heatmap values stored in said non-transitory storage medium, said altering or generating based, at least in part, on a measurement of one or more characteristics of wireless signals received by a receiver at a first wireless network access point and transmitted by a transmitter at a second wireless network access point, wherein at least one of said one or more characteristics comprises a processing delay;
determine a range between said first and said second wireless network access points;
derive at least one propagation parameter based, at least in part, on said processing delay and said determined range; and
alter said at least one heatmap value based, at least in part, on said at least one propagation parameter;
and
a wireless transceiver to:
transmit at least a portion of said collection of radio heatmap values including said altered or generated at least one radio heatmap value to a mobile station as positioning assistance information.

31. An apparatus for collecting heatmap information, comprising:
a non-transitory storage medium;
one or more processing units to:
alter or generate at least one radio heatmap value in a collection of radio heatmap values stored in said non-transitory storage medium, said altering or generating based, at least in part, on a measurement of one or more characteristics of wireless signals received by a receiver at a first wireless network access point and transmitted by a transmitter at a second wireless network access point;
determine ranges among said first and said second wireless network access points and a third wireless network access point;
derive one or more propagation parameters based, at least in part, on a measurement of one or more characteristics of wireless signals received by said receiver and transmitted by a second transmitter at said third wireless network access point; and
alter said at least one heatmap value based, at least in part, on said one or more propagation parameters;
and
a wireless transceiver to:
transmit at least a portion of said collection of radio heatmap values including said altered or generated at least one radio heatmap value to a mobile station as positioning assistance information.

32. (canceled)

33. (canceled)

34. An article comprising: a non-transitory storage medium comprising machine-readable instructions stored thereon that are executable by a special purpose computing device to:
alter or generate at least one radio heatmap value in a collection of radio heatmap values, said altering or generating based, at least in part, on a measurement of one or more characteristics of wireless signals received by a receiver at a first wireless network access point and transmitted by a transmitter at a second wireless network access point; and
transmit at least a portion of said collection of radio heatmap values including said altered or generated at least one radio heatmap value to a mobile station as positioning assistance information, wherein at least one of said one or more characteristics comprises a received signal strength, said article further comprising said non-transitory storage medium comprising machine-readable instructions stored thereon that are executable by said special purpose computing device to:
determine a range between said first and said second wireless network access points;
derive at least one propagation parameter based, at least in part, on said received signal strength and said determined range; and
alter said at least one heatmap value based, at least in part, on said at least one propagation parameter.

35. (canceled)

36. The article of claim 34, wherein said at least one propagation parameter comprises a value representative of signal strength loss per distance.

37. The article of claim 34, wherein said at least one propagation parameter comprises a value representative of transmission power of said transmitter.

38. The article of claim 34, wherein said at least one propagation parameter comprises a value representative of a transmission processing delay of said transmitter.

39. The article of claim 34, wherein said at least one propagation parameter comprises a value representative of a receiving processing delay of said receiver.

40. (canceled)

41. An article comprising: a non-transitory storage medium comprising machine-readable instructions stored thereon that are executable by a special purpose computing device to:
alter or generate at least one radio heatmap value in a collection of radio heatmap values, said altering or generating based, at least in part, on a measurement of one or more characteristics of wireless signals received by a receiver at a first wireless network access point and transmitted by a transmitter at a second wireless network access point; and
transmit at least a portion of said collection of radio heatmap values including said altered or generated at least one radio heatmap value to a mobile station as positioning assistance information, wherein at least one of said one or more characteristics comprises a processing delay, said article further comprising said non-transitory storage medium comprising machine-readable instructions stored thereon that are executable by said special purpose computing device to:
determine a range between said first and said second wireless network access points;
derive at least one propagation parameter based, at least in part, on said processing delay and said determined range; and
alter said at least one heatmap value based, at least in part, on said at least one propagation parameter.

42. An article comprising: a non-transitory storage medium comprising machine-readable instructions stored thereon that are executable by a special purpose computing device to:
alter or generate at least one radio heatmap value in a collection of radio heatmap values, said altering or generating based, at least in part, on a measurement of one or more characteristics of wireless signals received by a receiver at a first wireless network access point and transmitted by a transmitter at a second wireless network access point;
transmit at least a portion of said collection of radio heatmap values including said altered or generated at least one radio heatmap value to a mobile station as positioning assistance information;
determine ranges among said first and said second wireless network access points and a third wireless network access point;
derive one or more propagation parameters based, at least in part, on a measurement of one or more characteristics of wireless signals received by said receiver and transmitted by a second transmitter at said third wireless network access point; and
alter said at least one heatmap value based, at least in part, on said one or more propagation parameters.

43. (canceled)

44. (canceled)

45. A method at a first wireless network access point comprising:
obtaining measurements of one or more characteristics of at least one wireless signal transmitted by a transmitter of a second wireless network access point; and
transmitting said measurements to a server for use in altering or generating at least one radio heatmap value in a collection of radio heatmap values to be provided to a mobile station as positioning assistance information.

46. The method of claim 45, wherein at least one of said one or more characteristics comprises a received signal strength.

47. The method of claim 45, wherein said at least one of said collection of radio heatmap values are associated with locations along a line segment connecting said first and said second wireless network access points.

48. An apparatus for collecting heatmap information, the apparatus comprising:
means for obtaining measurements of one or more characteristics of at least one wireless signal transmitted by a transmitter of a second wireless network access point; and
means for transmitting said measurements to a server for use in altering or generating at least one radio heatmap value in a collection of radio heatmap values to be provided to a mobile station as positioning assistance information.

49. The apparatus of claim 48, wherein at least one of said one or more characteristics comprises a received signal strength.

50. The apparatus of claim 48, wherein said at least one of said collection of radio heatmap values are associated with locations along a line segment connecting said first and said second wireless network access points.

51. An apparatus for collecting heatmap information, the apparatus comprising:
a non-transitory storage medium;
one or more processing units to:
obtain measurements of one or more characteristics of at least one wireless signal transmitted by a transmitter of a second wireless network access point; and
a wireless transceiver to:
transmit said measurements to a server for use in altering or generating at least one radio heatmap value in a collection of radio heatmap values to be provided to a mobile station as positioning assistance information.

52. The apparatus of claim 51, wherein at least one of said one or more characteristics comprises a received signal strength.

53. The apparatus of claim 51, wherein said at least one of said collection of radio heatmap values are associated with locations along a line segment connecting said first and said second wireless network access points.

54. An article comprising: a non-transitory storage medium comprising machine-readable instructions stored thereon that are executable by a special purpose computing device to:
obtain measurements of one or more characteristics of at least one wireless signal transmitted by a transmitter of a second wireless network access point; and
transmit said measurements to a server for use in altering or generating at least one radio heatmap value in a collection of radio heatmap values to be provided to a mobile station as positioning assistance information.

55. The article of claim 54, wherein at least one of said one or more characteristics comprises a received signal strength.

56. The article of claim 54, wherein said at least one of said collection of radio heatmap values are associated with locations along a line segment connecting said first and said second wireless network access points.
